(19) United States
(12) Patent Application Publication
(10) Pub. No.: US 2024/0109813 A1
(43) Pub. Date: Apr. 4, 2024

(54) OXIDATION BARRIER MATERIALS AND PROCESS FOR CERAMIC MATRIX COMPOSITES

(71) Applicant: Oerlikon Metco (US) Inc., Westbury, NY (US)

(72) Inventors: Dianying CHEN, Westbury, NY (US); Aaron PEGLER, Anglikon (CH); Gopal DWIVEDI, Woodbury, NY (US); Mitchell R DORFMAN, Smithtown, NY (US)

(21) Appl. No.: 18/264,086

(22) PCT Filed: Feb. 4, 2022
(86) PCT No.: PCT/US2022/015276

§ 371 Date: Aug. 3, 2023

Related U.S. Application Data
(60) Provisional application No. 63/146,209, filed on Feb. 5, 2021.

(51) Int. Cl. C04B 35/622; C04B 35/16

(52) U.S. Cl. CPC C04B 35/62222; C04B 35/16; C04B 2235/5436; C04B 2235/5463; C04B 2235/77; C04B 2235/9607

(57) ABSTRACT

A method of applying an environmental barrier coating and an environmental barrier coating. The method includes applying a high apparent density powder via a high temperature and high velocity (HTHV) process. The high apparent density powder comprises at least one of rare earth silicates; mullite or alkaline silicate.

### BACKGROUND

### 1. Field of the Invention

Materials and processes to produce hermetic environmental barrier coatings (EBCs) to avoid spallation by thermally grown SiO₂ oxides (TGO).

### 2. Discussion of Background Information

Environmental barrier coatings (EBCs) have been applied onto Si-based ceramic matrix composites (CMCs) for the protection of CMCs from oxidation and water vapor attack. Currently, state of art EBC systems contains a Si bond coat and a rare earth disilicate intermediate layer and/or top coat. Rare earth disilicate has a coefficient of thermal expansion (CTE) that closely matches that of the underlying SiC substrate. In high temperature gas turbine engine environments, water vapor can penetrate through micro-cracks resulting in the coating to accelerate oxidation of the Si bond coat, which causes the spallation of the EBCs when the thermally grown oxides (TGO) reach a threshold thickness. As this spallation of environmental barrier coatings (EBCs) induced by thermally grown SiO₂ oxides (TGO) is a key EBC failure mode, it is important to control the TGO growth rate in order to improve the coating durability.

Conventionally, air plasma spray (APS) processes are normally used for depositing rare earth silicates coatings. However in the APS process, the particle velocity is generally lower (<200 m/s), which causes the significant SiO₂ loss and results in the inclusion of rare earth monosilicates phases in the deposited disilicates coatings. As monosilicate generally has a much larger CTE (=7.5×10⁻⁶/° C.) than that of disilicate (=4.1×10⁻⁶/° C.), the inclusion of larger CTE monosilicates phases in a disilicates coating will generate cracks during thermal cycling. The presence of such cracks in the coating will provide a transport path for oxidizing species to the silicon bond coat and result in the rapid growth of TGO and earlier failure of coatings. Therefore, controlling the phase composition in the disilicates coating is critical to achieve highly durable EBCs. In addition, porosity and micro-cracks are always present in the conventional APS EBCs which will facilitate the diffusion of oxidants through these micro-cracks and accelerate the silicon bond coat oxidation and therefore reduce the EBCs durability.

### SUMMARY

To reduce TGO growth rate, a hermetic and oxidation barrier layer is needed to prevent oxidants diffusion to the silicon bond coat surface.

Embodiments are directed to materials and processes to produce a hermetic EBC. Such a deposited hermetic EBC showed excellent oxidation resistance in a steam environment at high temperature with almost no TGO growth after 410 hours exposure in steam environment at 1316° C.

Embodiments are directed to using an exemplary high apparent density feedstock as EBC materials or raw materials, wherein “high apparent density” is defined in accordance with ASTM B212 as higher than 1.8 g/cc. The exemplary high apparent density powders can have a solid ceramic core, which is desired to prevent SiO₂ loss in the coating process. Further, a high temperature (where all or mean measured particle temperatures are above the melting temperature of the material composition), high velocity (where mean measured particle velocity is greater or equal to 200 m/s) coating process (HTHV) is used to deposit the exemplary EBCs. The particle velocity in the plasma jet in this HTHV process is over 200 m/s, and preferably between 400 m/s and 800 m/s, to produce dense coatings. By way of non-limiting example, the exemplary high apparent density powder according to embodiments can be a Yb₂Si₂O₇ feedstock or powder.

In accordance with embodiments, it has been found that there is almost no TGO growth after 410 hours exposure in steam environment at 1316° C. for the HTHV coating formed using the exemplary high apparent density powders.

A high temperature, high velocity (HTHV) thermal spray process can be used for depositing an exemplary coating on a substrate, by way of non-limiting example, rare earth silicates EBC deposition, preferably disilicates EBC deposition. For example, as the higher particle velocity (>200 m/s) achieved by an HTHV application process is greater than that available with the conventional APS process, a dense and micro-crack free EBC is deposited. This dense microstructure provides a diffusion barrier for oxidants (i.e., steam, oxygen) and, therefore, prevents oxidation of silicon bond coat. Moreover, experimental results have demonstrated that there is almost no TGO growth after 410 hours exposure in a steam environment at 1316° C. for exemplary coatings made using the high temperature and high velocity (HTHV) process. By way of non-limiting example, the exemplary rare earth silicate coating can be a Yb₂Si₂O₇/Si coating.

To prevent the significant SiO₂ loss of silica containing molten particles (such as rare earth silicates, preferably disilicates, and mullite) in the plasma jet, high apparent density powder feedstock or feedstock powders made using the high apparent density powders as raw materials are preferred. The high apparent density powders have a solid ceramic core, which is desired to prevent the SiO₂ loss in the coating process. The preferred apparent density is over 1.8 g/cc, preferably over 2.2 g/cc.

The high apparent density powders or the powder made using the high apparent density powders have a particle size distribution between 11 μm to 125 μm, preferably between 11 μm to 62 μm.

Using high apparent density powder feedstock, there is, e.g., only ˜6.0 v % Yb₂SiO₅ phase in the HTHV deposited Yb₂Si₂O₇ coatings, which is advantageous to keep the coating having a CTE matched with that of the substrate.

The high apparent density powders can be manufactured using the following processes:
1. Fused/crushed;
2. Agglomerated and sintered; and/or
3. Agglomerated and plasma densified.

The high temperature and high velocity thermal spray processes can be any of the following processes and can be operated in air atmosphere or in a vacuum atmosphere.
1. High temperature, high velocity atmosphere plasma spray process;
2. High temperature, high velocity vacuum plasma spray process; or
3. High temperature, high velocity oxy-fuel spray process.

In any of the above processes, the in-flight particles have an average velocity over 200 m/s, preferably over 400 m/s. Further, in the high temperature, high velocity vacuum plasma spray process, the vacuum ranges from 1 mbar to 100 mbar.

The high apparent density powder feedstock according to embodiments can have the following chemistries:
1. Rare earth silicates, preferably disilicates, such as RE₂Si₂O₇, where RE can be any of Y, La, Ce, Sc, Pr, Nd, Pm, Sm, Eu, Gd, Tb, Dy, Ho, Er, Tm, Yb, Lu;
2. Mullite;
3. Alkaline silicate (BaO—SrO—Al₂O₃—SiO₂);
4. Any of the above chemistries (1-3) with additional 0.5 wt %-10 wt % SiO₂ mixtures.
5. Materials with coefficients of thermal expansion ranging from 3.5×10⁻⁶/k-6×10⁻⁶/k.
6. Any combination of the above.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1A shows an exemplary powder made using a fused/crushed method;

FIG. 1B shows the exemplary powder made using an agglomerated and sintered method;

FIG. 2A shows an agglomerated and sintered powder made using pre-alloyed fused/crushed powders of the exemplary powder of FIG. 1A;

FIG. 2B shows an agglomerated and sintered powder made using pre-alloyed agglomerated and sintered powders of the exemplary powder of FIG. 1B;

FIGS. 3A and 3B are SEM images comparing TGO resulting from the conventional APS process and resulting from the high temperature, high velocity process according to the invention;

FIG. 4 is a table comparing phase compositions in an exemplary coating formed using the conventional APS process with phase compositions in an exemplary coating formed using the high temperature, high velocity process according to the invention; and

FIG. 5 shows a coating example according to the invention.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

To prevent significant SiO₂ loss of silica containing molten particles (such as rare earth silicates, preferably disilicates, and mullite) in the plasma jet, high apparent density powder feedstock or feedstock powders made using the high apparent density powders as raw materials is preferred. The high apparent density powders have a solid ceramic core, which is desired to prevent the SiO₂ loss in the coating process. The preferred apparent density is over 1.8 g/cc, preferably over 2.2 g/cc.

The high apparent density powders can be manufactured using the following processes:
1. Fused/crushed;
2. Agglomerated and sintered; and/or
3. Agglomerated and plasma densified.

Moreover, powders made according to these processes have a phase purity over 95 v %.

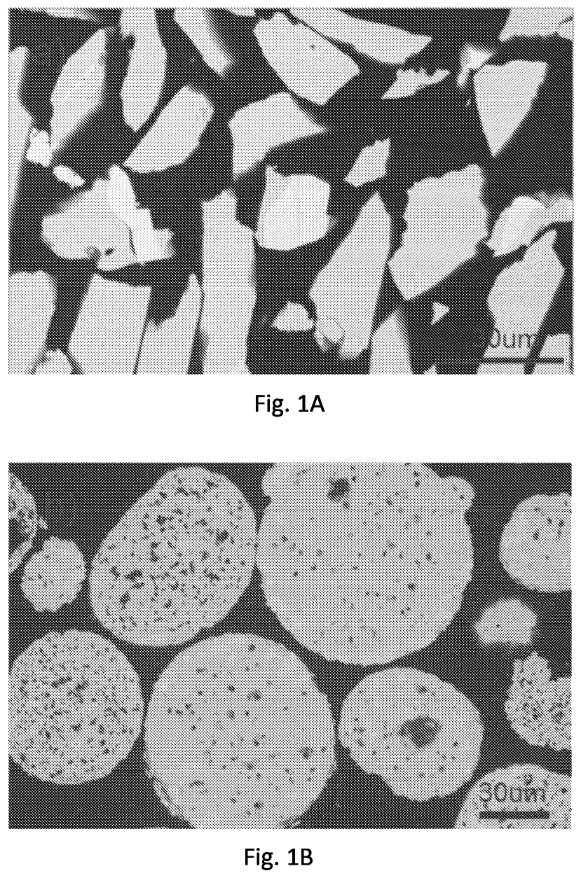

FIGS. 1A and 1B show high apparent density and high phase purity powders. As shown in FIG. 1A, an exemplary high apparent density powder, e.g., a rare earth silicate, such as a Yb₂Si₂O₇ powder, can be made using fused/crushed method. Such a fused/crushed exemplary Yb₂Si₂O₇ powder has an apparent density greater than 2.2 g/cc. FIG. 1B shows a high apparent density powder, e.g., a rare earth silicate, such as a Yb₂Si₂O₇ powder, that can be made using an agglomerated and sintered method. Such an agglomerated and sintered exemplary Yb₂Si₂O₇ powder has an apparent density over 2.4 g/cc. The powders of FIGS. 1A and 1B have a phase purity over 95 v %.

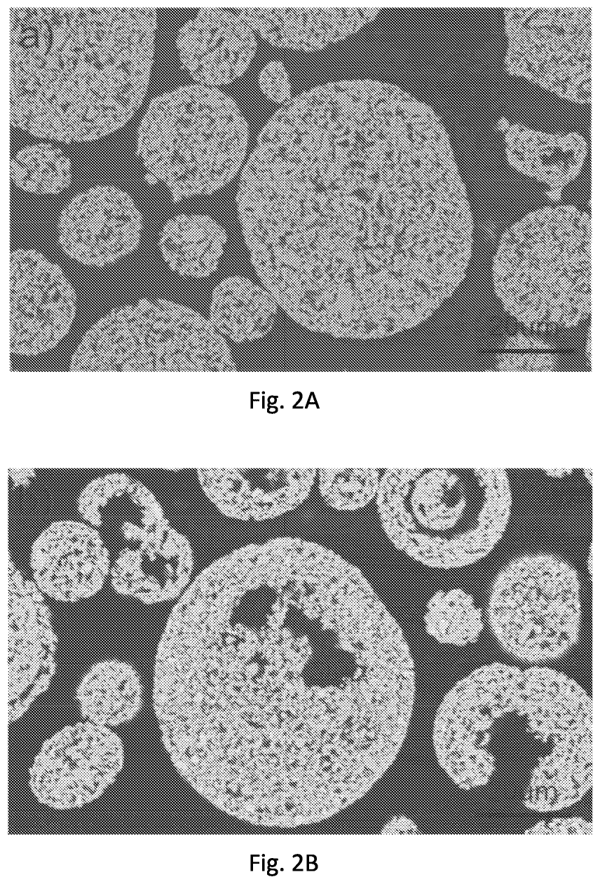

FIGS. 2A and 2B show exemplary powders made using the above high apparent density and high purity powders (i.e., pre-alloyed powders) as raw materials. Thus, in addition to the direct use of the above-described high apparent density and high phase purity powders as feedstock for thermal spray EBCs, these high apparent density and high phase purity pre-alloyed powders can also be used as raw materials for a relatively lower apparent density powder manufacturing. In these embodiments, the high apparent density and high phase purity powders shown in FIGS. 1A and 1B are milled down to size less than 10 μm, preferably less than 3 μm, and then these finer powders can be agglomerated and sintered to desired particle size distribution ranging from 11 μm to 105 μm, preferably from 11 μm to 62 μm. FIG. 2A shows an agglomerated and sintered exemplary powder, e.g., a rare earth silicate, such as a Yb₂Si₂O₇ powder, made using pre-alloyed fused/crushed powders of FIG. 1A. This agglomerated and sintered exemplary Yb₂Si₂O₇ powder has an apparent density of over 1.4 g/cc. FIG. 2B shows an agglomerated and sintered exemplary powder, e.g., a rare earth silicate, such as a Yb₂Si₂O₇ coating, made using pre-alloyed agglomerated and sintered powders of FIG. 1B. Such an agglomerated and sintered exemplary Yb₂Si₂O₇ powder has an apparent density over 1.6 g/cc. The advantage in these embodiments is that these low apparent density powders, which are made using the pre-alloyed higher apparent powders as raw materials, can prevent the loss of SiO₂ from the particles in the high temperature spray process, and can result in a high purity coating so that, using the HTHV process, dense coatings can be made using these low apparent powders.

Moreover, the exemplary high apparent density powder or pre-alloyed processed exemplary high apparent density powder feedstock is not limited to the above-identified rare earth silicates, but can have the following chemistries:
1. Rare earth silicates, preferably disilicates, such as RE₂Si₂O₇, where RE can be any of Y, La, Ce, Sc, Pr, Nd, Pm, Sm, Eu, Gd, Tb, Dy, Ho, Er, Tm, Yb, Lu;
2. Mullite;
3. Alkaline silicate (BaO—SrO—Al₂O₃—SiO₂);
4. Any of the above chemistries (1-3) with additional 0.5 wt %-10 wt % SiO₂ mixtures.
5. Materials with coefficients of thermal expansion ranging from 3.5×10⁻⁶/k-6×10⁻⁶/k.
6. Any combination of the above.

The high apparent density powders according to embodiments can be deposited using a high temperature, high velocity (HTHV) thermal spray process to form an EBC. As this HTHV process produces a higher particle velocity (>200 m/s) than can be achieved through the conventional APS process, it has been found that a dense, e.g., <5% porosity, and micro-crack free EBC is deposited. This dense microstructure provides a diffusion barrier for oxidants (i.e., steam, oxygen) and, therefore, prevents oxidation of silicon bond coat. Preferably, the HTHV process produces a particle velocity of greater than 400 m/s.

Moreover, the HTHV thermal spray processes can be any of the following processes and can be operated in air atmosphere or in a vacuum atmosphere.
1. High temperature, high velocity atmosphere plasma spray process;
2. High temperature, high velocity vacuum plasma spray process; or
3. High temperature, high velocity oxy-fuel spray process.

In any of the above processes, the in-flight particles have an average velocity over 200 m/s, preferably over 400 m/s. Further, in the high temperature, high velocity vacuum plasma spray process, the vacuum ranges from 1 mbar to 100 mbar.

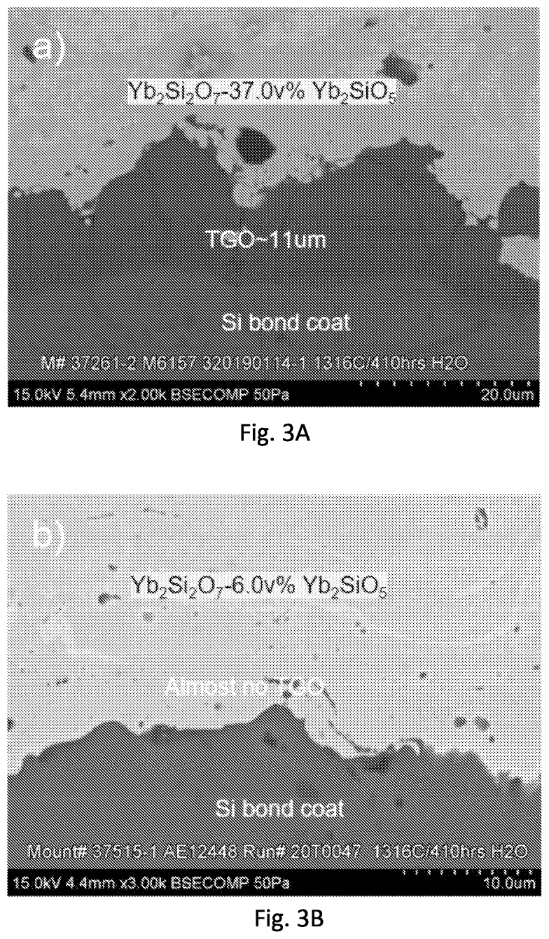

FIGS. 3A and 3B show SEM images to compare TGO growth after exposing an exemplary EBC system, e.g., a Yb₂Si₂O₇/Si EBC system, to a 90% H₂O—10% O₂ environment at 1316° C. for 410 hrs. The SEM image of FIG. 3A, which shows a Yb₂Si₂O₇/Si EBC system made using the conventional low velocity APS process, shows an ˜11 μm thick TGO between the Si bond coat and the applied Yb₂Si₂O₇ layer. In contrast, the SEM image of FIG. 3B, which shows a Yb₂Si₂O₇/Si EBC system made with a high temperature high velocity (HTHV) process, shows, almost no discernible TGO growth between the Si bond coat and the Yb₂Si₂O₇ layer.

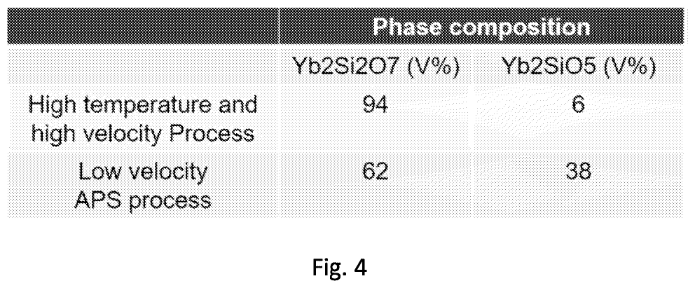

FIG. 4 provides a table comparing the phase composition of exemplary coatings, e.g., a rare earth silicate coating such as Yb₂Si₂O₇, made with the conventional low velocity process versus the phase composition of the exemplary coatings made with the high velocity HTHV process. From this table, it is shown that the phase composition of the low velocity APS deposited Yb₂Si₂O₇(disilicate) coating includes an ˜38.0 v % Yb₂SiO₅ (monosilicate) phase, while only an ˜6.0 v % Yb₂SiO₅ (monosilicate) phase is present in the HTHV deposited Yb₂Si₂O₇(disilicate) coating. Because this monosilicate Yb₂SiO₅ has a much larger CTE (=7.5×10⁻⁶/° C.) than that of the disilicate Yb₂Si₂O₇ (=4.1×10⁻⁶/° C.), the volume reduction of CTE monosilicate phases in the disilicate coating deposited by the HTHV process will result in a dense and micro-crack free EBC, as compared to the coating deposited by the APS process, which generates cracks during thermal cycling to create a transport path for oxidizing species to the silicon bond coat. Therefore, controlling the phase composition in the disilicates coating in accordance with the disclosed embodiments is advantageous in order to achieve highly durable EBCs. However, it is understood that some rare earth monosilicates having low CTE may be advantageously utilized as an EBC via the high velocity HTHV process discussed above.

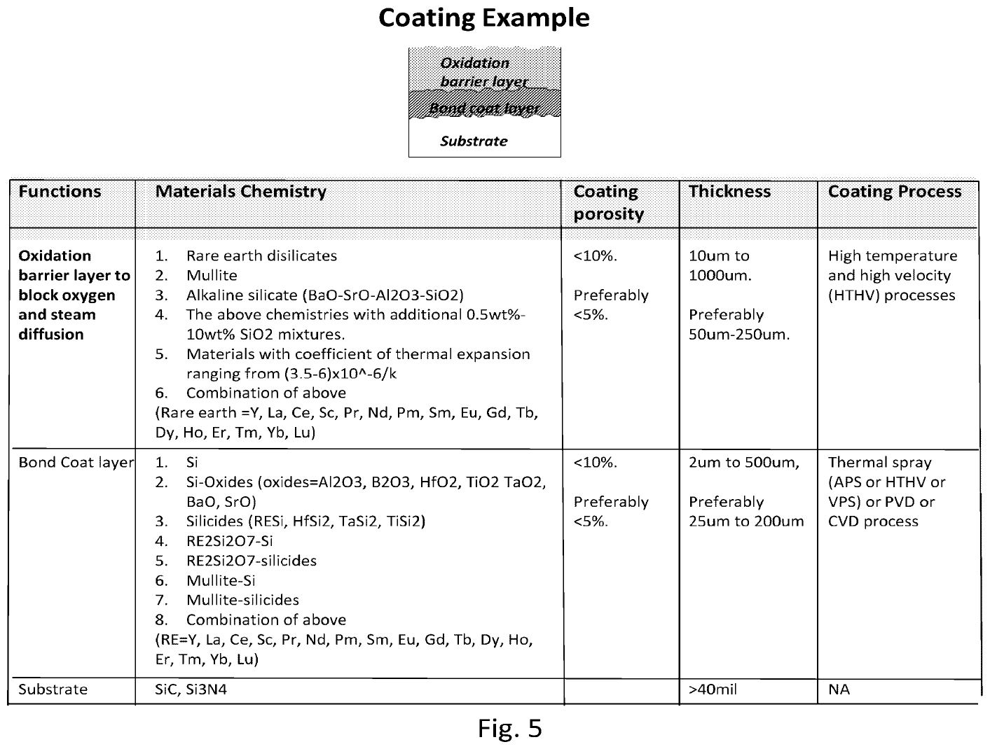

In accordance with embodiments, FIG. 5 shows a coating example in accordance with embodiments. The exemplary coating is formed on a substrate of, e.g., SiC or Si₃N₄, having a thickness of greater than 40 mil. The exemplary coating can include a bond coat layer deposited on the substrate having a thickness of 2 μm to 500 μm and preferably 25 μm to 200 μm. This bond coat layer can be applied by a thermal spray process, such as APS, HTHV or vacuum plasma spraying, or by a physical vapor deposition process or by a chemical vapor deposition process to have a porosity of less than 10% and preferably less than 5%. Further, the bond coat layer can have the following chemistries:
1. Si;
2. Si-oxides, e.g., Al₂O₃, B₂O₃, HfO₂, TiO₂, TaO₂, BaO, SrO;
3. Silicides, e.g., RESi, HfSi₂, TaSi₂, Ti₂Si₂;
4. RE₂Si₂O₇—Si;
5. RE₂Si₂O₇-silicides;
6. Mullite-Si
7. Mullite-silicides
8. Combinations of the above.

### Moreover, RE can be any of Y, La, Ce, Sc, Pr, Nd, Pm, Sm, Eu, Gd, Tb, Dy, Ho, Er, Tm, Yb or Lu.

The exemplary coating can also include an oxidation barrier layer that is formed on the bond coat layer to block oxygen and steam diffusion. The oxidation barrier layer deposited on the bond coat layer can have a thickness of 10 μm to 1000 μm and preferably 50 μm to 250 μm. This oxidation barrier layer is applied according to the embodiments by an HTHV process to have a porosity of less than 10% and preferably less than 5%. Further, the oxidation barrier layer can have the following chemistries:
1. Rare earth silicates, preferably disilicates, such as RE₂Si₂O₇, where RE can be any of Y, La, Ce, Sc, Pr, Nd, Pm, Sm, Eu, Gd, Tb, Dy, Ho, Er, Tm, Yb or Lu;
2. Mullite
3. Alkaline silicate (BaO, SrO, Al₂O₃ or SiO₂);
4. The chemistries of 1-3 with additional 0.5 wt %-10 wt % SiO₂ mixtures;
5. Materials with coefficients of thermal expansion ranging from 3.5×10⁻⁶/k-6×10⁻⁶/k;
6. Any combination of the above.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1-20. (canceled)

21. A method of applying an environmental barrier coating comprising:
applying a high apparent density powder via a high temperature and high velocity (HTHV) process,
wherein the high apparent density powder, having an apparent density of greater than 1.8 g/cc, comprises at least one of rare earth silicates; mullite or alkaline silicate, and
wherein powders of the high apparent density powder have solid ceramic cores.

22. The method according to claim 21, wherein the alkaline silicate comprises BaO, SrO, Al₂O₃, or SiO₂.

23. The method according to claim 21, wherein the high apparent density powder further comprises 0.5 wt %-10 wt % SiO₂ mixtures.

24. The method according to claim 21, wherein the high apparent density powder further comprises materials having coefficients of thermal expansion ranging from 3.5×10⁻⁶/k-6×10⁻⁶/k.

25. The method according to claim 21, wherein the HTHV process produces a particle velocity of greater than 200 m/s.

26. The method according to claim 25, wherein the HTHV process produces a particle velocity of greater than 400 m/s.

27. The method according to claim 21, wherein the HTHV process comprises one of: a high temperature, high velocity atmosphere plasma spray process; a high temperature, high velocity vacuum plasma spray process; or a high temperature, high velocity oxy-fuel spray process.

28. The method according to claim 21, wherein the rare earth silicates comprise a disilicate.

29. The method according to claim 28, wherein the disilicate comprises RE2Si2O7, where RE can be any of Y, La, Ce, Sc, Pr, Nd, Pm, Sm, Eu, Gd, Tb, Dy, Ho, Er, Tm, Yb or Lu.

30. The method according to claim 21, wherein the rare earth silicates comprise a low coefficient of thermal expansion monosilicate.

31. An environmental barrier coating comprising:
a dense coating comprising at least one of rare earth silicates; mullite; or alkaline silicate.

32. The environmental barrier coating according to claim 31, wherein the alkaline silicate comprises BaO, SrO, Al₂O₃, or SiO₂.

33. The environmental barrier coating according to claim 31, wherein the high apparent density powder further comprises 0.5 wt %-10 wt % SiO₂ mixtures.

34. The environmental barrier coating according to claim 31, wherein the high apparent density powder further comprises materials having coefficients of thermal expansion ranging from 3.5×10⁻⁶/k-6×10⁻⁶/k.

35. The environmental barrier coating according to claim 31, wherein the rare earth silicates comprise a disilicate.

36. The environmental barrier coating according to claim 35, wherein the disilicate comprises RE2Si2O7, where RE can be any of Y, La, Ce, Sc, Pr, Nd, Pm, Sm, Eu, Gd, Tb, Dy, Ho, Er, Tm, Yb or Lu.

37. The environmental barrier coating according to claim 31, wherein the rare earth silicates comprise a low coefficient of thermal expansion monosilicate.

38. The method according to claim 21, wherein the apparent density is greater than 2.2 g/cc.

39. The method according to claim 21, wherein the powders of the high apparent density powder have a particle size distribution between 15 μm and 125 μm.

40. The method according to claim 39, wherein the powders of the high apparent density powder have a particle size distribution between 15 μm and 62 μm.
